(19) United States
(12) Patent Application Publication
(10) Pub. No.: US 2014/0281971 A1
(43) Pub. Date: Sep. 18, 2014

(54) METHODS AND SYSTEMS FOR GENERATING OBJECTIVE SPECIFIC PLAYLISTS

(71) Applicant: United Video Properties, Inc., Santa Clara, CA (US)

(72) Inventors: Marion William Isbell, III, Los Angeles, CA (US); Michael Nichols, La Canada, CA (US)

(73) Assignee: United Video Properties, Inc., Santa Clara, CA (US)

(21) Appl. No.: 13/799,135

(22) Filed: Mar. 13, 2013

(51) Int. Cl. G06F 3/0484; G06F 17/30

(52) U.S. Cl. CPC G06F 3/0484; G06F 17/30053
USPC 715/716

(57) ABSTRACT

Methods and systems as described herein for a media guidance application capable of generating media playlists geared to particular purposes. Specifically, the media guidance application described herein can customize a media playlist based on a travel itinerary and a determined objective for a current trip as well as update the media playlist upon detecting a change in the travel itinerary or determined objective.

### BACKGROUND

People commonly access playlists of media content both for entertainment and educational purposes. The media content may appeal to a person's interest or may correspond to a particular task to be performed (e.g., listening to up-beat, motivating music while exercising). These playlists may include media assets in a random order or an order determined by another entity (e.g., music broadcasted over the radio). Alternatively, a person may create his or her own playlist by arranging media assets in a particular order.

While creating a playlist benefits the user as the user is able to select the particular media content he or she wishes to hear, creating a playlist is also time consuming. Furthermore, as the advent of digital music players, mobile computing devices, and other devices capable of presenting audio and video content to users has increased the number of activities that a person can perform while accessing media assets, a user may find that devoting large amounts of time to creating playlists, customized for each activity and situation, is inefficient.

### SUMMARY

Accordingly, methods and systems as described herein for a media guidance application capable of generating media playlists geared to particular purposes. Specifically, the media guidance application described herein can customize a media playlist based on a travel itinerary and a determined objective for a current trip as well as update the media playlist upon detecting a change in the travel itinerary or determined objective.

For example, the media guidance application may determine the travel itinerary (e.g., destination, travel time, route information, etc.) for a user. Furthermore, the media guidance application may determine a particular objective (e.g., entertaining a user, minimizing jetlag of the user, presenting geographically relevant information, etc.) for the media playlist. Based on the determined travel itinerary and the determined objective, the media guidance application generates a media playlist for presentation to the user. In addition, the media guidance application monitors for changes in either the determined travel itinerary (e.g., an adjustment of a flight path) or the determined objective (e.g., a user, previously wanting to be entertained, now wanting to sleep). Upon detecting either a change in the travel itinerary or a change in the determined objective, the media guidance application rectifies the playlist based on the change.

In some embodiments, the media guidance application may generate a media playlist by determining a length of time corresponding to the current trip of the user, determining a play length for one or more media assets, which meet the determined objective criteria, and selecting one or more media assets, wherein the sum of the play length for the one or more media assets corresponds to the length of time corresponding to the current trip of the user. For example, the media guidance application may determine that a user will be on a flight for four hours based on the estimated time of arrival associated with the flight. The media guidance application may further determine an objective of the user is to sleep. In response, the media guidance application may retrieve a plurality of media assets featuring soothing music (e.g., to encourage sleeping). The media guidance application may then compile the soothing music into a playlist that lasts the four hours of the flight.

In some embodiments, the media guidance application may determine a change in the determined objective automatically. For example, the media guidance application may incorporate or have access to one or more modules that can monitor bio-metric data related to a user. By monitoring the bio-metric data related to the user, the media guidance application can detect a status change in the user (e.g., the user falling asleep). The media guidance application may then cross-reference the status change of the user in a database to determine whether or not the detected status change affects the determined objective. If so, the determined objective may be changed automatically.

In some embodiments, the media guidance application generates and updates a media playlist based on a bio-metric objective of a user. For example, the media guidance application determines a bio-metric objective associated with a user, and generates the media playlist based on the bio-metric objective, in which the media playlist includes a first media asset selected to achieve the bio-metric objective. The media guidance application then receives bio-metric data about the user and compares the bio-metric data to the bio-metric objective. If the media guidance application determines that the bio-metric data does not correspond to the bio-metric objective (i.e., the media playlist is not having the intended effect on a user), the media guidance application rectifies the media playlist to include a second media asset selected to achieve the bio-metric objective.

In some embodiments, the media guidance application may determine media playlist objectives without requiring a user input. For example, in some embodiments, the media guidance application receives a detail of a travel itinerary associated with a current trip. Based on the detail, the media application determines a purpose of the current trip. The media guidance application may then cross-reference the purpose of the current trip with a database of playlist objectives to identify a playlist objective for the current trip, and, based on the playlist objective, generates a media playlist for presentation during the current trip.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance application in accordance with some embodiments of the disclosure;

FIG. 2 shows another illustrative example of a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative example of a media playlist creation display in a media guidance application in accordance with some embodiments of the disclosure;

FIG. 6 is an illustrative example of a travel itinerary display screen in accordance with some embodiments of the disclosure;

FIG. 7 is an illustrative example of a display screen used in conjunction with a media playlist to present geographically relevant information in accordance with some embodiments of the disclosure;

FIG. 8 is a flowchart of illustrative steps for generating a media playlist in accordance with some embodiments of the disclosure;

FIG. 9 is a flowchart of illustrative steps for determining a change in an objective associated with the media playlist in accordance with some embodiments of the disclosure;

FIG. 10 is a flowchart of illustrative steps for populating a media playlist with media assets that correspond to the objective and time requirements of the playlist in accordance with some embodiments of the disclosure;

FIG. 11 is a flowchart of illustrative steps for generating and updating a media playlist based on bio-metric data of a user in accordance with some embodiments of the disclosure; and

FIG. 12 is a flowchart of illustrative steps for automatically determining media playlist objectives based on a purpose of a current trip in accordance with some embodiments of the disclosure.

### DETAILED DESCRIPTION OF DRAWINGS

The amount of content available to users in any given content delivery system can be substantial. Consequently, many users desire a form of media guidance through an interface that allows users to efficiently navigate content selections, easily identify content that they may desire, and present the content in a playlist. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens.

In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

As described herein, a media guidance application may generate media playlists featuring media guidance data and media assets for presentation to a user. Specifically, the media guidance application may determine a travel itinerary and an objective associated with a current trip of a user as well as any updates and/or changes to the travel itinerary and/or objective. If any updates and/or changes are determined, the media playlist may rectify the playlist to reflect the changes in the travel itinerary and/or determined objective.

As used herein, a “travel itinerary” refers to a description of the circumstances and/or progress of a current trip of a user. For example, a travel itinerary may include numerous details associated with the travel itinerary, including, but not limited to, the location of departure and/or arrival (e.g., including, but not limited to, the geographical location, entry/exit requirements, customs and/or activities associated with the location, things-to-do, cultural elements and/or attractions, etc.), length of travel (e.g., including, but not limited to, time and/or distance spent travelling, time spent at one or more locations, etc.), time of departure and/or arrival (e.g., including any time-zone changes), anticipated stops (e.g., layovers), route (e.g., either currently taken or expected to take), of the current trip of the user. In addition, details associated with the travel itinerary may include activities or occurrence that occurs before or after a current trip. For example, a business meeting scheduled a day after the end of a current trip (e.g., as indicated by a calendar application associated with the user) may be related to the current trip (e.g., a user was travelling to the business meeting). In some embodiments, this information, or any of the other details explained above and below, may be used to determine a purpose of the trip and/or objective of a media playlist as described below.

For example, in some embodiments, the travel itinerary describes, including, but not limited to, the destination of a current trip, the route of a current trip, and the length of time associated with the current trip. For example, the media guidance application may use the travel itinerary of the current trip of the user to determine that a playlist needs to be four hours long because the user will spend four hours travelling.

In some embodiments, a current trip may be divided into one or more sub-trips, and the media guidance application may generate a media playlist for each. For example, a trip may include several different sub-trips defined by different modes of transportation (e.g., a car ride to an airport, an airplane flight to a different city, a bus ride to a hotel, etc.). In another example, sub-trips may be defined by different destinations (e.g., an airplane flight to one city, a layover at the city, a second airplane flight to a different city, etc.). It should be noted that any disclosure herein may be applied equally to a trip or sub-trip. Furthermore, a playlist for a trip may include several sub-playlists corresponding to different sub-trips. In some embodiments, the details for one sub-trip may affect the media playlist of another sub-trip. For example, an early morning connection or business meeting may cause the media guidance application to adjust the media playlist such that the user is well-rested or does not miss the connection/meeting.

Throughout this disclosure, embodiments and examples are discussed with reference to various methods and modes of transportation. It should be noted that any embodiments described herein with reference to one method or mode of transportation may also be applied to another mode of transportation. For example, an embodiment or example describing the use of a media guidance application in relation to an airplane (or any other method or mode of transportation) may also be applied to a cruise-ship, bus, train, car, motorcycle, bicycle, etc., or any other method or mode of transportation, whether public or private, and whether powered mechanically (e.g., car, train, etc.), manually (e.g., walking, bicycle, etc.), or powered by any other means (e.g., horse, sailboat, etc.).

The media guidance application may also determine an objective of the current trip. The objective of the trip may be as generic or specific as desired by a user. For example, an objective may include entertaining a user. Additionally or alternatively, an objective may include entertaining a user in a specific way (e.g., displaying movies corresponding to specific criteria, presenting geographically relevant information, and/or presenting information about the destination, including but not limited to, the language, geography, culture, politics, and public transportation systems, etc.). In another example, an objective may include facilitating sleeping by the user (e.g., presenting soothing media assets, including but not limited to, presenting no media assets for a period of time) and/or facilitating sleeping for a specific period of time (e.g., generating reminders to sleep and/or wake-up at particular times). The objective may also include objective criteria, which relate to tasks and/or requirements for fulfilling an objective.

In some embodiments, the media guidance application may receive an objective that involves presenting user instructions to assist the user in specific actions (e.g., minimizing the jetlag of a user, notifying a user when a meal is being served, preventing the user from consuming too much coffee/alcohol, etc.). For example, the objective received by the media guidance application may be to minimize the jetlag of a user. In order to do so, the media guidance application may receive information associated with a user (e.g., the current sleep schedule of a user) and information associated with the current trip (e.g., a time zone differential between the departure and destination) for use in generating a playlist to meet the objective. Based on a comparison of the information, the media guidance application may generate a playlist that includes specific user prompts (e.g., prompts to go to sleep, stop drinking coffee, drink water, or wake up in order for a user to adjust his or her current sleep schedule for the new time zone).

In another example, the objective received by the media guidance application may be to notify a user when a meal or beverage is being served (e.g., in order to ensure the user is not currently asleep). In order to do so, the media guidance application may receive information associated with a user (e.g., whether or not the user is currently asleep or present) and information associated with the meal or beverage service (e.g., when a meal or beverage service is being served). Based on a comparison of the information, the media guidance application may generate a playlist that include specific user prompts (e.g., prompts to go to sleep or wake up in order for a user to adjust his or her schedule to be awake or present during the meal or beverage service).

Based on the determined travel itinerary and the determined objective, the media guidance application generates a media playlist for presentation to the user. In addition, the media guidance application monitors for changes in either the determined travel itinerary (e.g., an adjustment of the expected arrival time) or the determined objective. In order to detect changes and/or updates in the either the determined travel itinerary or the determined objective, the media guidance application may incorporate or have access to a detection module which may include various components (e.g., a video detection component, an audio detection component, bio-metric component, etc.). Upon detecting either a change in the travel itinerary or a change in the determined objective, the media guidance application may rectify the playlist based on the change.

Throughout this disclosure, embodiments and examples are discussed with reference to a single user. It should be noted that any embodiments described herein with reference to a single user may also be applied to multiple users. For example, a media guidance application could determine a media playlist for several users (e.g., a family traveling together or a tour group) simultaneously.

FIGS. 1-2 show illustrative display screens that may be used to provide media guidance data. The display screens shown in FIGS. 1-2 and 5-7 may be implemented on any suitable user equipment device or platform. While the displays of FIGS. 1-2 and 5-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, selectable option 204 is selected. Selectable option 204 corresponds to a playlist creation option. For example, the media guidance application may generate display 500 (FIG. 5) in response to the selection of selectable option 204. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listings 208, 210, and 212 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

User equipment device 300 may also incorporate or be accessible to detection module 316. Detection module 316 may further include various components (e.g., a video detection component, an audio detection component, etc.) for determining and/or detecting changes to information about the travel itinerary and/or objectives of the user. In some embodiments, detection module 316 may include components that are specialized to generate particular information. For example, detection module 316 may include components for use in detecting and/or retrieving information about a user (e.g. bio-metric data) and/or the actions and/or activities of the user (e.g., whether or not a user is sleeping).

For example, in some embodiments, a detection module 316 may include an eye contact detection component, which determines or receives a location upon which one or both of a user's eyes are focused or whether or not the user's eye lids are open. The location upon which a user's eyes are focused is referred to herein as the user's “gaze point.” In some embodiments, the eye contact detection component may monitor one of both eyes of a user of user equipment 300 to identify a gaze point on display 312 for the user.

The eye contact detection component may, additionally or alternatively, determine whether one or both eyes of the user are focused on display 312 (e.g., indicating that a user is viewing display 312), focused on a location that is not on display 312 (e.g., indicating that a user is not viewing display 312), or whether or not a user's eye lids are open (e.g., indicating that a user is asleep). In some embodiments, the eye contact detection component includes one or more sensors that transmit data to processing circuitry 306, which determines a user's gaze point. The eye contact detection component may be integrated with other elements of user equipment device 300, or the eye contact detection component, or any other component of detection module 316 and may be a separate device or system in communication with user equipment device 300.

In some embodiments, detection module 316 may include a breathing cycle detection component, which determines or receives information describing a user's breathing habits. The breathing cycle of a user when typically sleeping is referred to herein as the user's “resting breathing cycle.” In some embodiments, the breathing cycle detection component may monitor a breathing cycle (e.g., the inhaling and exhaling of air) of a user of user equipment 300 to identify the resting breathing cycle. The breathing cycle detection component may, additionally or alternatively, determine whether or not the user is breathing faster than a resting breathing cycle associated with the user (e.g., indicating that a user is awake) or whether or not the current breathing of the user corresponds to the resting breathing cycle associated with the user (e.g., indicating that a user is sleeping). In some embodiments, the breathing cycle detection component includes one or more sensors that transmit data to processing circuitry 306, which determines a user's breathing cycle. The breathing cycle detection component may be integrated with other elements of user equipment device 300, or the eye contact detection component, or any other component of detection module 316 and may be a separate device or system in communication with user equipment device 300.

Additionally or alternatively, detection module 316 may include other components used to determine other bio-metric measurements of a user (e.g., a heartbeat, breathing pattern, a blood pressure, a blood-alcohol level, an internal temperature, etc.). For example, the detection module 316 may incorporate a heartbeat monitor, a breathalyzer, a thermometer, etc.

In some embodiments, detection module 316 may include an audio/video detection component, which determines or receives information describing objects in images and/or noise emanating from a user or other sources (e.g., a public address announcement related to a user's travel itinerary in an airport or airplane). For example, the audio/video detection component may, additionally or alternatively, determine whether or not the user is talking (e.g., indicating that a user is awake) or snoring (e.g., indicating that a user is sleeping) by processing the audio/video data. Additionally or alternatively, the audio detection component may monitor for images and/or sounds originating from other sources that may be related to a user's current trip or travel itinerary. In some embodiments, the audio/video detection component includes one or more sensors that transmit data to processing circuitry 306, which determines a change and/or update to a user's travel itinerary, a user status, and/or objective.

For example, detection module 316 may include one or more content-recognition modules, which may be used by the media guidance application to analyze information received from a content capture device (e.g., video and/or audio recorder). For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects in and/or characteristics of video and audio recordings. For example, the media guidance application may receive a media asset in the form of a video (e.g., an audio/video recording of a user in a seat of an airplane). The video may include a series of frames. For each frame of the video, the media guidance application may use an object recognition module to determine the characteristics associated with each frame (or the media assets as a whole) of the video (e.g., whether or not the user's eyelids are open, whether or not the user's chest is expanding and contracting in a manner corresponding to a resting breathing cycle).

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text. The content-recognition module may also use any other suitable techniques for processing audio and/or visual data. For example, the content-recognition module may analyze audio data to determine whether or not a user is talking, snoring, etc. Furthermore, the content-recognition module may analyze video and/or audio data to determine changes to a user's travel itinerary, a user status, and/or objective.

In addition, the media guidance application may use multiple types of optical character recognition and/or fuzzy logic, for example, when comparing multiple data fields (e.g., as contained in databases described below). For example, after the content-recognition module or algorithm translates video and/or audio recordings into text, the media guidance application (e.g., via control circuitry 304) may cross-reference the translated text with a database (e.g., located at storage 308 or media guidance data source 418 (FIG. 4)) to determine whether or not the translated text corresponds to data associated with a user's travel itinerary, a user status change, and/or objective.

For example, the media guidance application may arrange the text into data fields and cross-reference the data fields with other data fields (e.g., in a lookup table database) corresponding to possible values associated with a user's travel itinerary, a user status change, and/or objective. Using fuzzy logic, the system may determine two fields and/or values to be identical even though the substance of the data field or value (e.g., two different spellings) is not identical. In some embodiments, the system may analyze particular data fields of a data structure or media asset frame for particular values or text. The data fields could be associated with characteristics, other data, and/or any other information required for the function of the embodiments described herein. Furthermore, the data fields could contain values (e.g., the data fields could be expressed in binary or any other suitable code or programming language).

In some embodiments, detection module 316 may include a Global Positioning System (“GPS”) detection component, which determines or receives information describing the geographic position of a user. For example, the GPS detection component may, additionally or alternatively, determine whether or not the user is taking a particular route (e.g., whether or not the current position of a user corresponds to a position in the route), is on schedule (e.g., whether or not the current position of a user corresponds to the position the user is scheduled to be at in the route based on the current time), or the current travelling speed of the user. In some embodiments, the GPS detection component includes one or more sensors that transmit data to processing circuitry 306, which determines a change and/or update to a user's travel itinerary, a user status, and/or objective.

In some embodiments, detection module 316 may include an Internet access component, which determines or receives information describing the current trip retrieved over the Internet. For example, the Internet access component may, additionally or alternatively, determine whether or not information on the Internet (e.g., a web-site of an airline) indicates a change or update to the determined travel itinerary or the determined objective of the user. Additionally or alternatively, detection module 316 may include a vehicle access component, which determines or receives information (e.g., from the odometer of a car) describing the current trip retrieved from the vehicle. For example, the media guidance application may be configured to receive information from the flight control system of an airplane. In some embodiments, the Internet access component and vehicle access component may transmit data to processing circuitry 306, which determines a change and/or update to a user's travel itinerary, a user status, and/or objective.

For example, detection module 316 may access and/or receive commands from systems and/or data associated with the method or mode of transportation. For example, detection module 316 may receive specific inputs from the media control system associated with the method or mode of transportation (e.g., an airline IFE system). Furthermore, the media guidance application may incorporate information and/or commands. For example, during a flight, detection module 316 may incorporate pilot/flight attendant announcements, flight/navigation equipment signals, and/or data collected on previous flights to adjust a media playlist. Furthermore, the media guidance application may determine when or how to deliver/incorporate commands. For example, the media guidance application may wait to deliver messages based on a user's status (e.g., not delivering a message while the user is sleeping) or the criticality (e.g., via analyzing tags associated with a command) of an announcement (e.g., urgent information is delivered immediately, whereas non-critical information is delivered when convenient).

In some embodiments, detection module 316 may access and/or receive commands from systems and/or data associated with the user. For example, detection module 316 may access a bio-metric application on a device associated with a user to interface with or pull data about the user. For example, if the data retrieved from the user's device indicates the user did not sleep well, the media guidance application may adjust the media playlist and/or update an objective of the media playlist based on this information (e.g., extending a scheduled nap time).

It should be noted detection module 316 may also interface with other users and/or people near a user. For example, detection module 316 may determine (e.g., via the detection methods above) whether other users and/or people near the user are talking, sleeping, moving about the vehicle, being active, performing duties (e.g., whether a flight attendant is currently serving food or is taking a break), etc. This information may also be used to generate a media playlist.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 shows an illustrative example of a media playlist creation display in a media guidance application in accordance with some embodiments of the disclosure. It should be noted that display 500 is illustrative only and should not be taken to be limiting in any manner. For example, in some embodiments, one or more of the features of display 100 and/or display 200 may be incorporated into display 500. Display 500 may appear on the display (e.g., display 312 (FIG. 3)) of a user equipment device (e.g., user equipment device 402, 404, and/or 406 (FIG. 4)).

Display 500 is a playlist creation display. For example, display 500 may appear is response to a user selection (e.g., via user input interface 310 (FIG. 3)) of selectable option 204 (FIG. 2)). Display 500 includes playlist 514, which includes several media assets. Playlist 514 may include title 534, which may, in some embodiments, correspond to the current trip and the objective of the playlist. For example, playlist 514 includes Movie A 502, Sleep Reminder A 504, Soothing Music A 506, Wake-up Announcement A 508, Location Information A 510, and Location Information B 512. The media guidance application may have selected one or more of the media assets in playlist 514 according to one or more objectives (e.g., as indicated by Objective A option 516 and Objective B option 518) after a user selected create option 230 (e.g., via a user input interface 310 (FIG. 3)). The media assets in playlist 514 may, in some embodiments, be displayed in interface 522. Additionally or alternatively, interface 522 may appear in a full-screen size, and one or more of the features in display 500 may appear as an overlay on interface 522.

For example, the media guidance application may determine (e.g., by a user input received via user input interface 310 (FIG. 3) or via information received via detection module 316 (FIG. 3)) that the playlist has two objectives, minimizing the jetlag of a user and presenting location information to the user. In order to minimize jetlag, the media guidance application may select media assets aimed at adjusting the sleep schedule of a user to coincide with any time zone differences between the point of departure and destination of the current trip of the user. For example, Movie A 502 may be a somber movie that relaxes a user in order to facilitate the user falling asleep. Sleep Reminder A may be an on-screen prompt (e.g., featured in interface 522) reminding the user to go to sleep, stop drinking caffeinated drinks, or any other suitable message. Soothing Music A may be sleep inducing sounds (e.g., presented using speakers 314 (FIG. 3)) that may aid a user in sleeping.

Wake up Announcement A may be an on-screen prompt (e.g., featured in interface 522) or an alarm (e.g., presented using speakers 314 (FIG. 3)) aimed at awakening a user at a particular time (e.g., a time determined to minimize jetlag). Location Information A 510 and Location Information B 512 may fulfill the objective defined in Objective B option 518 and present location specific information to the user (e.g., as described in relation to FIG. 7).

Display 500 also includes options for defining, retrieving, monitoring, and/or updating itinerary information. For example, in response to a user selection (e.g., via input interface 310 (FIG. 3)) of Itinerary Information option 520, the media guidance application may generate for display in interface 522 information about the travel itinerary of the current trip (e.g., as described in relation to FIG. 6)). In some embodiments, Itinerary Information option 520 may include a navigation system in which a user may input a destination and a route (e.g., travel route 606 (FIG. 6)) to that destination is computed.

In some embodiments, one or more of the features of display 500 (e.g., Objective A option 516, Itinerary Information option 520, automatic update option 526, etc.) may be selected based on a user profile. For example, many features could be pre-populated and stored in a frequent flyer account associated with a user. Furthermore, playlists and/or feature selections from previous trips could be stored and retrieved. In some embodiments, the media guidance application may retrieve media playlist stored and/or associated with the method or mode of transportation. For example, a bus may have preferred media playlist for each route, which in some embodiments, may change over time based on user or system feedback. In such cases, the preferred media playlist may be selectable by a user. In another example, all users associated with a tour group may be assigned a media playlist by the tour leader. In some embodiments, a current trip may be associated with a sponsored playlist. For example, the media guidance application may retrieve a media playlist provided by a third party (e.g., a tourism group associated with the destination).

Display 500 also includes options for initiating a bio-metric analysis (e.g., as described in relation to FIG. 9). For example, in response to a user selection (e.g., via input interface 310 (FIG. 3)) of Bio-metric Analysis option 528, the media guidance application may rectify a playlist upon detecting a change in the status of the user based on a bio-metric analysis (e.g., as described below in relation to FIG. 9).

Display 500 also includes automatic update option 526. In some embodiments, the media guidance application may determine a change in the determined objective automatically following a user selection (e.g., received via input interface 310 (FIG. 4)) of automatic update option 526. In some embodiments, the media guidance application may select automatic update option 526 by default. For example, the media guidance application may incorporate or have access to one or more modules that can monitor bio-metric data related to a user (e.g., detection module 316 (FIG. 3)). By monitoring the bio-metric data related to the user, the media guidance application can detect a status change in the user (e.g., the user falling asleep). In some embodiments, the media guidance application may then cross-reference the status change of the user in a database (e.g., a database located locally (e.g., storage 308 (FIG. 3)) or remotely (e.g., media content source 416, media guidance data source 418, or any location accessible via communications network 414 (FIG. 4)) to determine whether or not the detected status change affects the determined objective. If so, the determined objective may be changed automatically.

In another example, the media guidance application may incorporate or have access to one or more modules that can monitor GPS data related to a current position of the user (e.g., detection module 316 (FIG. 3)). By monitoring the GPS data related to the user, the media guidance application can detect a change in the determined travel itinerary of the user (e.g., the user is using a different route, the user is behind schedule in his or her route based on the current time, etc.). In some embodiments, the media guidance application may then cross-reference the travel itinerary change in a database (e.g., a database located locally (e.g., storage 308 (FIG. 3)) or remotely (e.g., media content source 416, media guidance data source 418, or any location accessible via communications network 414 (FIG. 4)) to determine whether or not the change affects the playlist (e.g., the play length of the playlist needs to be longer). If so, the playlist may be rectified automatically.

In some embodiments, display 500 may include options, or Objective A option 516 may encompass, description of the purpose of the current trip. For example, a determination that a user is on a business trip may automatically cause the media guidance application to generate a playlist that will minimize jetlag, whereas a determination that a user is on a vacation may automatically cause the media guidance application to generate a playlist that will entertain the user.

FIG. 6 is an illustrative example of a travel itinerary display screen in accordance with some embodiments of the disclosure. It should be noted that display 600 is illustrative only and should not be taken to be limiting in any manner. For example, in some embodiments, one or more of the features of display 100 and/or display 200 may be incorporated into display 600. Display 600 may appear on the display (e.g., display 312 (FIG. 3)) of a user equipment device (e.g., user equipment device 402, 404, and/or 406 (FIG. 4)). Furthermore, in some embodiments, display 600 may correspond to interface 522 (FIG. 5).

Display 600 shows a graphical display of a travel itinerary associated with the current trip of the user. For example, display shows destination 602 and departure point 604. Display 600 also includes travel route 606 and current position 610 as well as additional display information 608 (e.g., an International Date Line, times zone changes, municipal borders, etc.).

In some embodiments, the media guidance application determines destination 602, departure point 604, travel route 606, and/or current position 610 based on various sources (e.g., user input interface 310 and/or detection module 316 (FIG. 3)). For example, the media guidance application may receive user inputs (e.g., via user input interface 310 (FIG. 3)) into a display (e.g., display 500 (FIG. 5)) to determine one or more of destination 602, departure point 604, travel route 606, current position 610, and/or any other information related to the travel itinerary.

In some embodiments, the media guidance application may determine one or more of destination 602, departure point 604, travel route 606, current position 610, and/or any other information related to the travel itinerary without user input (e.g., via detection module 316 (FIG. 3)). For example, to determine the length of time of a current trip, the media guidance application may receive information from the airline (e.g., via accessing a web-site associated with the airline or receiving an e-mail or other information from the airline).

In some embodiments, the media guidance application may retrieve destination 602, departure point 604, travel route 606, current position 610 and/or any other information related to the travel itinerary from a database. For example, the media guidance application may determine the destination (e.g., destination 602) of a current trip of a user. In addition, the media guidance application may determine the current position (e.g., current position 610) and speed of the user (e.g., via detection module 316 (FIG. 3)). The media guidance application may further determine the route (e.g., travel route 606) from the current position of the user to the destination by cross-referencing a database related to route information. For example, the media guidance application may incorporate or have access to a local (e.g., located at storage 308 (FIG. 3)) or remote (e.g., located at media content source 416 (FIG. 4)), media guidance data source 418 (FIG. 4), and/or a device/location accessible via communications network 414 (FIG. 4)) database (e.g., a lookup table) in which the media guidance application may input the destination and current position to determine the shortest and/or quickest route.

Furthermore, in some embodiments, the media guidance application may compute (e.g., via processing circuitry 306 (FIG. 3)) the destination 602, departure point 604, travel route 606, current position 610 and/or any other information related to the travel itinerary based on mathematical computations involve other characteristics of the travel itinerary. For example, having determined the distance to the destination (e.g., destination 602) from the current position of a user (e.g., current position 610), the route (e.g., travel route 606), and/or speed of travel from one or more of the methods described above, the media guidance application may apply suitable mathematical operations (e.g., dividing the distance by the speed to determine the length of time remaining in the current trip) to determine any other information related to the travel itinerary.

The media guidance application may then use the determined travel itinerary to generate a playlist (e.g., playlist 514 (FIG. 5)) based at least in part on a determined objective (e.g., an objective specified in Objective A option 516 (FIG. 5)). For example, based on the determined travel itinerary and/or objective the media assets (e.g., Movie A 502, Sleep Reminder A 504, Soothing Music A 506, Wake-up Announcement A 508, Location Information A 510, and Location Information B 512 (FIG. 5)) of a playlist (e.g., playlist 514 (FIG. 5)) presented to a user may keep the passenger awake for a period of time and then lull them to sleep with gentle nature sounds (such as light rainfall) and then increase the tempo of selected media assets before arrival at the destination (e.g., destination 602). Furthermore, if any changes and/or updates to the determined travel itinerary and/or objective is detected and/or determined (e.g., via one of the devices and/or methods described above), the media guidance application may adjust the playlist ordering or the selected media assets (e.g., as discussed below in relation to FIG. 8).

In some embodiments, display 600 may customize its appearance based on the destination of the current trip. For example, if it is currently raining at the destination, display 600 may appear darker, even though the destination is still several hours away. For example, the colors, background, characters, etc. appearing on the display could reflect the time of day or conditions of the destination. In some embodiments, display 600 may include information about the destination or types of information that would be displayed to a user, if the user was currently at the location. For example, if it is currently a weekday morning, the media playlist may include morning commute information. If it is currently the weekend, the media playlist may include Saturday cartoons.

For example, the media guidance application may receive information (e.g., via an Internet access component of detection module 316 (FIG. 3)), which indicates, along with the current time, the current weather conditions at the destination of the user. The media guidance (e.g., via processing circuitry 306 (FIG. 3)), may cross-reference this information with a database (e.g., located at storage 308 (FIG. 3), media content source 416 (FIG. 4), media guidance data source 418 (FIG. 4), and/or a device/location accessible via communications network 414 (FIG. 4)) to determine the particular templates, colors, audio indications, etc. that represent the conditions of the destination. Based on this determination, the media guidance application may customize its appearance by adopting the particular templates, colors, audio indications, etc. that represent the conditions of the destination.

FIG. 7 is an illustrative example of a display screen used in conjunction with a media playlist to present geographically relevant information in accordance with some embodiments of the disclosure. It should be noted that display 700 is illustrative only and should not be taken to be limiting in any manner. For example, in some embodiments, one or more of the features of display 100 and/or display 200 may be incorporated into display 700. Display 700 may appear on the display (e.g., display 312 (FIG. 3)) of a user equipment device (e.g., user equipment device 402, 404, and/or 406 (FIG. 4)). Furthermore, in some embodiments, display 700 may correspond to interface 522 (FIG. 5).

In some embodiments, display 700 may correspond to a media asset, or content displayed in conjunction with, a media asset displayed in a playlist (e.g., playlist 514 (FIG. 5)). For example, in some embodiments, in response to a user selection (e.g., via user interface 310 (FIG. 3)) requesting geographically relevant information (e.g., as an objective entered into Objective A option 516 (FIG. 5)), the media guidance application may present display 700.

In some embodiments, display 700 may present a view of the current position of a user (e.g., current position 610 (FIG. 6)) as it may appear outside a vehicle the user is currently travelling in. For example, display 700 may present a ground view (as observed from an airplane) of the area that a user is currently passing.

Display 700 includes indication 702 and indication 704. Indications 702 and 704 may notify the user of relevant geographical features that the user is near. For example, in some embodiments, the media guidance application may coordinate media assets (e.g., Location Information A 510 and Location Information B 512 (FIG. 5)) in a playlist (e.g., playlist 514 (FIG. 5)) with the current position of a user (e.g., current position 610 (FIG. 6)).

For example, based on the current position of the user (e.g., as determined by detection module 316 (FIG. 3), information received via user input interface 310 (FIG. 3), mathematical computations of processing circuitry 306 (FIG. 3), and/or information received from a cross-reference with a database located at storage 308 (FIG. 3), media content source 416 (FIG. 4), media guidance data source 418 (FIG. 4), and/or a device/location accessible via communications network 414 (FIG. 4)), the media guidance application may present geographically relevant media assets (e.g., geographically relevant advertisements, information about the current position and/or destination, including, but not limited to, the language, geography, culture, politics, and public transportation systems, local attractions, historical information, local custom and/or activities, and/or any other content associated with the position of the user).

For example, if the media guidance application determines (e.g., via detection module 316 (FIG. 3)) that the user is near a rainforest of Brazil, the playlist (e.g., playlist 514 (FIG. 5)), may present indigenous music, rainforest themed movies, jungle sounds, zoology information, Brazilian/rainforest trivia and/or information, advertisements about activities related to Brazil, etc. In another example, if the media guidance application determines (e.g., via detection module 316 (FIG. 3)) that the user is travelling across the United States, the media guidance application may present prerecorded information about the area the passenger is flying over (e.g., replicating traditional oral activity such as a pilot, tour leader, or captain describing the area). In another example, if the media guidance application determines (e.g., via detection module 316 (FIG. 3)) that the user is about to reach New York City, the media guidance application may present Frank Sinatra's “New York, N.Y.”

FIG. 8 is a flowchart of illustrative steps for generating a media playlist in accordance with some embodiments of the disclosure. Process 800 may be used to generate a media playlist (e.g., playlist 514 (FIG. 5)) on display device (e.g., display 500 (FIG. 5)). It should be noted that process 800 or any step thereof, could occur on, or be provided by, any of the devices shown in FIGS. 3-4. For example, process 800 may be executed by control circuitry 304 (FIG. 3) as instructed by the media guidance application (e.g., implemented on any of the devices shown and described in FIG. 4).

At step 802, the media guidance application is initiated. For example, in some embodiments, the media guidance application may be initiated when the user device (e.g., user equipment 402, 404, and/or 406 (FIG. 4)) upon which the media guidance application is implemented is powered-on. In some embodiments, the media guidance application may be initiated in response to a user input (e.g., via user input interface 310 (FIG. 3) selecting selectable option 204 (FIG. 2)).

At step 804, the media guidance application determines whether or not travel itinerary information is being received by a user input. For example, in some embodiments, the media guidance application determines travel itinerary information (e.g., destination 602, departure point 604, travel route 606 (FIG. 6)) based on various sources. For example, the media guidance application may receive user inputs (e.g., via user input interface 310 (FIG. 3)) describing the travel itinerary (e.g., via Itinerary Information option 520 (FIG. 5)). For example, in some embodiments, the media guidance application may include a navigation system for receiving destination coordinates. If the media guidance application receives the travel information via a user input, the media guidance application proceeds to step 808.

If the media guidance application does not receive travel itinerary information via a user input, the media guidance application proceeds to step 806 and retrieves travel itinerary information without user input before proceeding to step 808. For example, the media guidance application may determine travel itinerary information using detection module 316 (FIG. 3)). For example, to determine the route of a flight, the media guidance application may cross-reference a database located locally (e.g., storage 308 (FIG. 3)) or remotely (e.g., media content source 416, media guidance data source 418, and/or any device located via communications network 414 (FIG. 4)) describing a potential flight path associated with the flight.

At step 808, the media guidance application determines a travel itinerary associated with a current trip. For example, based on the travel itinerary information received either by a user input (e.g., step 804) or without a user input (e.g., step 806), the media guidance application determines a travel itinerary associated with a current trip. For example, in response to receiving a destination (e.g., destination 602 and departure point 604 (FIG. 6)), the media guidance application may determine any remaining information (e.g., travel route 606 (FIG. 6) or the length of time of the current trip) necessary to generate a playlist (e.g., playlist 514 (FIG. 5)).

At step 810, the media guidance application determines whether or not it has received a user input of an objective. For example, the media guidance application may receive a user input of an objective (e.g., via Objective A option 516 (FIG. 5) or may determine an objective automatically. If the media guidance application receives a user input of an objective, the media guidance application proceeds to step 816.

If the media guidance application does not receive a user input of an objective, the media guidance application proceeds to step 812. At step 812, the media guidance application prompts a user for an objective. For example, the media guidance application may display a message requesting an objective or listing available objectives (e.g., on interface 522 (FIG. 5)). Additionally or alternatively, the media guidance application may cross-reference information about the user in a database. For example, the media guidance application may incorporate or have access to a local (e.g., located at storage 308 (FIG. 3)) or remote (e.g., located at media content source 416 (FIG. 4)), media guidance data source 418 (FIG. 4), and/or a device/location accessible via communications network 414 (FIG. 4)) database (e.g., a lookup table) in which the media guidance application may query (e.g., request a sleep schedule of a user) to determine that a user is likely to want to sleep or a time at which the user should sleep. If the response to the query indicates the user is likely to want to sleep, the media guidance application may determine (e.g., in step 814) that the objective is to assist the user in sleeping. For example, the objective may be a bio-metric objective as discussed in relation to FIG. 11 below.

At step 814, the media guidance application determines an objective for the user. For example, the media guidance application may determine a particular objective (e.g., entertaining a user, minimizing jetlag of the user, presenting geographically relevant information, etc.) for the playlist (e.g., playlist 514 (FIG. 5)). In some embodiments, the objective may be changed and/or updated during the current trip as described in relation to FIG. 9 below.

At step 816, the media guidance application generates a playlist based on the determined length of time corresponding to the current trip and the determined objective. As described in detail in relation to FIG. 10, to generate the playlist, the media guidance application may (e.g., via control circuitry 304 (FIG. 3)), select one or more media assets (e.g., retrieved from a database located locally (e.g., storage 308 (FIG. 3)) or remotely (e.g., media content source 416 (FIG. 4)), in which the sum of the play length for the selected media assets corresponds to the length of time corresponding to the current trip of the user, and in which the media assets correspond to the determined objective. For example, the media guidance application may determine that a user will be on a flight for four hours based on the estimated time of arrival associated with the flight. The media guidance application may further determine an objective of the user is to sleep. The media guidance application may retrieve a plurality of media assets featuring soothing music (e.g., to encourage sleeping). The media guidance application may then compile the soothing music into a playlist that lasts the four hours of the flight.

At step 818, the media guidance application presents a playlist. For example, the media guidance application may present a playlist (e.g., playlist 514 FIG. 5)) to a user on a display (e.g., display 312 (FIG. 3)) of a user equipment device (e.g., user equipment device 402, 404, and/or 406 (FIG. 4)).

At step 820, the media guidance application monitors for a change in the itinerary. For example, the media guidance application may incorporate or have access to one or more modules that can monitor GPS data related to a current position of the user (e.g., detection module 316 (FIG. 3)). By monitoring the GPS data related to the user, the media guidance application can detect a change in the determined travel itinerary of the user (e.g., the user is using a different route, the user is behind schedule in his or her route based on the current time, etc.).

Additionally or alternatively, the media guidance application may incorporate or have access to one or more modules that can monitor audio/video data related to the current trip of the user (e.g., detection module 316 (FIG. 3)). By monitoring the audio/video data related to the current trip, the media guidance application can detect an announcement regarding a change in the determined travel itinerary of the user (e.g., a public announcement broadcasted within the cabin of an airplane).

If a change in the determined itinerary is detected, the media guidance application returns to step 804. By returning to step 804, the media guidance application can rectify the playlist by determining a new travel itinerary. The media guidance application may then rectifying (e.g., update) the playlist (e.g., playlist 514 (FIG. 5)) presented in step 818. If a change is not detected, the media guidance application proceeds to step 822. At step 822, the media guidance application determines (e.g., via control circuitry 304 (FIG. 3)) whether the end of the playlist has been reached. If not, the media guidance application returns to step 820 to monitor for a change to the determined itinerary. If the end of the playlist has been reached, process 800 ends at step 824.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

FIG. 9 is a flowchart of illustrative steps for determining a change in an objective associated with the media playlist in accordance with some embodiments of the disclosure. Process 900 may be used to generate a media playlist (e.g., playlist 514 (FIG. 5)) on display device (e.g., display 500 (FIG. 5)). It should be noted that process 900 or any step thereof, could occur on, or be provided by, any of the devices shown in FIGS. 3-4. For example, process 900 may be executed by control circuitry 304 (FIG. 3) as instructed by the media guidance application (e.g., implemented on any of the devices shown and described in FIG. 4).

At step 902, the media guidance application determines an objective. For example, in some embodiments, this step may correspond to step 814 (FIG. 8). For example, in some embodiments, the media guidance application may determine an objective, or objective criteria, based on information received from one of more sources (e.g., detection module 316 (FIG. 3), information received via user input interface 310 (FIG. 3), mathematical computations of processing circuitry 306 (FIG. 3), and/or information received from a cross-reference with a database located at storage 308 (FIG. 3), media content source 416 (FIG. 4), media guidance data source 418 (FIG. 4), and/or a device/location accessible via communications network 414 (FIG. 4)).

For example, the media guidance application may receive user inputs (e.g., via user input interface 310 (FIG. 3)) into a display (e.g., display 500 (FIG. 5)) to determine one or more objectives. Alternatively or additionally, the media guidance application may determine one or more objectives without user input (e.g., via detection module 316 (FIG. 3)). For example, the media guidance application may determine the objective of a current trip is to sleep by receiving bio-metric data (e.g., via detection module 316 (FIG. 3)) indicating that the user is currently sleeping. In another example, the media guidance application may determine that, based on a cross-reference with a database, a user typically sleeps at the current time. For example, the media guidance application may incorporate or have access to a local (e.g., located at storage 308 (FIG. 3)) or remote (e.g., located at media content source 416 (FIG. 4)), media guidance data source 418 (FIG. 4), and/or a device/location accessible via communications network 414 (FIG. 4)) database (e.g., a lookup table) in which the media guidance application may query (e.g., request a sleep schedule of a user) to determine that a user is likely to want to sleep or a time at which the user should sleep (e.g., to minimize jetlag).

At step 904, the media guidance application may generate a playlist (e.g., playlist 514 (FIG. 5)) based at least in part on a determined objective (e.g., an objective specified in Objective A option 516 (FIG. 5)) and a determined travel itinerary (e.g., as discussed in relation to FIG. 6)). For example, based on the determined travel itinerary and objective, the media guidance application selects the media assets (e.g., Movie A 502, Sleep Reminder A 504, Soothing Music A 506, Wake-up Announcement A 508, Location Information A 510, and Location Information B 512 (FIG. 5)) of a playlist (e.g., playlist 514 (FIG. 5)) presented to a user.

At step 906, the media guidance application presents a playlist (e.g., playlist 514 (FIG. 5)) to a user (e.g., on display 312 (FIG. 3) of user equipment device 402, 404, and/or 406 (FIG. 4)). In some embodiments the playlist may be displayed with an accompanying interface (e.g., interface 522 (FIG. 5)), which may display various features (e.g., features related to those discussed in FIGS. 1-2 and 6-7). In some embodiments, the playlist may be displayed in a full-screen (e.g., display 500 (FIG. 5)) or partial-screen (e.g., as discussed in relation to FIG. 2)) display.

At step 908, the media guidance application determines whether or not automatic updates are initiated. For example, in some embodiments, the media guidance application may determine a change in the determined objective or travel itinerary automatically (e.g., via selecting Automatic Update option 526 (FIG. 5)). In some embodiments, the media guidance application may initiate automatic updates by default (e.g., Automatic Update option 526 (FIG. 5) is selected “On” by default). If automatic updates are not initiated, the media guidance application returns to step 906.

If automatic updates are initiated, the media guidance application proceeds to step 910. At step 910, the media guidance application determines whether or not bio-metric analysis is initiated. For example, in some embodiments, the media guidance application may determine a change in the bio-metric activity of a user automatically (e.g., via selecting Bio-metric Analysis option 528 (FIG. 5)). In some embodiments, the media guidance application may initiate automatic updates by default (e.g., Bio-metric Analysis option 528 (FIG. 5) is selected “On” by default). If bio-metric analysis is not initiated, the media guidance application proceeds to step 914.

If bio-metric analysis is initiated, the media guidance application proceeds to step 912. At step 912, the media guidance application determines whether or not a change to the bio-metrics of a user is detected. For example, as described in relation to FIG. 3 above, the media guidance application may incorporate or have access to various sources of information, including bio-metric data associated with a user. For example, detection module 316 (FIG. 3) may include various components (e.g., a video detection component, an audio detection component, etc.) as well as components for use in detecting and/or retrieving information about a user (e.g., bio-metric data). For example, the media guidance application may detect changes in both physiological (e.g., drowsiness, perspiration level, etc.) and behavioral (e.g., awareness, activeness, voice patterns, anxiety, etc.) characteristics of a user.

If the media guidance application detects a change to the bio-metrics of a user, the media guidance application returns to step 902. For example, the media guidance application may incorporate or have access to one or more modules that can monitor bio-metric data related to a user (e.g., detection module 316 (FIG. 3)). By monitoring the bio-metric data related to the user, the media guidance application can detect a status change in the user (e.g., the user falling asleep). For example, the eye contact detection component or the breathing cycle detection component, incorporated into and/or accessible to the media guidance application (e.g., via detection module 316 (FIG. 3)), may detect a user has fallen asleep. The determined objective (e.g., the objective determined in step 902) may not coincide with the status change of the user. For example, the determined objective may be to present geographically relevant information (e.g., as discussed in relation to FIG. 7)). However, if a user is sleeping, the media guidance application may determine (e.g., via control circuitry 304 (FIG. 3)) that the objective does not coincide with the current status of the user, and the media guidance application returns to step 902 and determines a new objective (e.g., facilitating sleeping by the user).

If the media guidance application does not detect a change to the bio-metrics of a user, the media guidance application proceeds to step 914. At step 914, the media guidance application determines whether or not there is a change to the objective (e.g., unrelated to the bio-metrics of a user). For example, while the playlist (e.g., playlist 514 (FIG. 5)) is being presented, the media guidance application may receive a user input (e.g., via user input interface 310 (FIG. 3)) adjusting an objective (e.g., adjusting Objective A option 516 (FIG. 5)). If no change is detected, the media guidance application returns to step 906. If a change is detected, the media guidance application returns to step 902 and determines a new objective.

In some embodiments, before returning to step 902, the media guidance application may cross-reference the detected change in a database (e.g., a database located locally (e.g., storage 308 (FIG. 3)) or remotely (e.g., media content source 416, media guidance data source 418, or any location accessible via communications network 414 (FIG. 4)) to determine whether or not the detected change affects the determined objective. If not, the media guidance application may proceed to step 906.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

FIG. 10 is a flowchart of illustrative steps for populating a media playlist with media assets that correspond to playlist and time in accordance with some embodiments of the disclosure. Process 1000 may be used to generate a media playlist (e.g., playlist 514 (FIG. 5)) on display device (e.g., display 100 (FIG. 5)). It should be noted that process 1000 or any step thereof, could occur on, or be provided by, any of the devices shown in FIGS. 3-4. For example, process 1000 may be executed by control circuitry 304 (FIG. 3) as instructed by the media guidance application (e.g., implemented on any of the devices shown and described in FIG. 4). Generating playlists according to particular criteria, for example, is described in greater detail in Kramer et al., U.S. patent application Ser. No. ______, “Methods and Systems for Generating Shaped Playlists,” Attorney Docket No. 003597-0835-101, filed Mar. 13, 2013, which is hereby incorporated by reference herein in its entirety.

At step 1002, the media guidance application retrieves a media asset for a playlist. For example, upon determining the travel itinerary and determined objective, the media guidance application may populate a playlist (e.g., playlist 514 (FIG. 5)) with media assets. In some embodiments, the available media assets, which may be used to populate the playlist may be stored locally (e.g., at storage 308 (FIG. 3)) or remotely (e.g., at media content source 416, media guidance data source 418, and/or any location accessible via communication network 414 (FIG. 4)).

In some embodiments, the available media assets may be stored in a database, which may also include additional information describing characteristics associated with available media assets. For example, a field in the database may indicate whether or not a media asset has a particular tempo, genre, mood, etc. This information may be used by the media guidance application to determine whether or not the media asset corresponds to an objective to entertain, facilitate sleeping, etc. For example, a media asset with an upbeat tempo may correspond to an objective to entertain a user, but may not correspond to an objective to help a user sleep. Likewise, classical music may not correspond to an objective to entertain a user (e.g., based on the preferences of a user), but may correspond to an objective to help a user sleep.

Additionally or alternatively, the database may store user profile information. For example, the database may indicate whether or not a user enjoys a particular media asset. If the user enjoys the media asset, then the media asset may correspond to an objective to entertain a user. In some embodiments, the user profile may contain additional information about the user necessary to generate a playlist according to a particular objective. For example, the media guidance application may retrieve information on the sleep schedule of the user (e.g., in order to generate a playlist to minimize jetlag).

At step 1004, the media guidance application determines whether or not the retrieved media assets correspond to the playlist objective. For example, the objective (e.g., as indicated by Objective A option 516 (FIG. 5)) for a playlist (e.g., playlist 514 (FIG. 5)) may be to facilitate sleeping by the user; therefore, the media guidance application selects only media asset that will facilitate that objective.

In another example, the objective (e.g., as indicated by Objective A option 516 (FIG. 5)) for a playlist (e.g., playlist 514 (FIG. 5)) may be to present geographically relevant information. For example, the media guidance application may receive a user request to play music associated with an area in which the user is currently traveling or will be travelling. Accordingly, when the user is travelling through a particular country, the media guidance application presents music typically associated with or popular in the particular country. In another example, if a travel itinerary indicates (e.g., route 606 (FIG. 6)) that a user is travelling over an ocean, the media guidance application may present ocean sounds.

In order to present media assets corresponding to the determined objective (e.g., the objective indicated in Objective A option 516 (FIG. 5)), the media guidance application may cross-reference the database describing characteristics associated with available media assets. For example, in some embodiments, the database storing the available media assets (e.g., located at storage 308 (FIG. 3) and/or media content source 416 (FIG. 4)) may also include information describing the media assets. The media guidance application may cross-reference this information to identify media assets corresponding to the determined objective.

If the retrieved media asset does not correspond (e.g., as indicated by the information associated with the media asset describing the characteristics of the media asset) to the playlist objective, the media guidance application proceeds to step 1006 and selects a different media asset. If the retrieved media does correspond to the playlist objective, the media guidance application proceeds to step 1008.

In some embodiments, the media guidance application may shape a playlist according to the particular objective. For example, in response to a user selection to be awoken prior to landing, the media guidance application may generate a playlist with low tempo media assets at the beginning of the playlist (e.g., to encourage a user to sleep) and high tempo media assets at the end of the playlist (e.g., prior to landing). Furthermore, the media guidance application may populate the playlist with media assets gradually increasing in tempo such that the user is gradually awoken. Furthermore, in response to a user selection of an objective to wake-up at a particular point in a flight (e.g., corresponding to a meal service), the media guidance application may generate a playlist with a high tempo media asset in the middle of the playlist and low tempo media assets at the beginning and the end of the playlist. The media guidance application may generate a playlist with media assets that gradually increase in tempo and peak at the high tempo media asset. The generated playlist then features media assets with gradually decreasing tempos until a low tempo is reached (e.g., helping a user fall back to sleep).

In such cases, the media guidance application may interpolate the media assets that are needed. For example, the media guidance application may interpolate the characteristics (e.g., the speed of the tempo) of each media asset necessary to generate a playlist that achieves the determined objective. The media guidance application may use any suitable interpolation method (e.g., including, but not limited to, piecewise constant interpolation, including, but not limited to, piecewise cubic hermite interpolation and shape-preserving piecewise cubic interpolation, linear interpolation, polynomial interpolation, and/or spline interpolation). In addition, the media guidance application may use Gaussian processes both to determine an interpolant that passes exactly through given data points, but also for fitting a curve through noisy data (e.g., a regression analysis).

For example, the media guidance application may (e.g., via processing circuitry 306 (FIG. 3)) determine an interpolant of a characteristic of two media assets using linear interpolation. In some embodiments, a linear interpolation may be expressed by equation 1 below:

$$y = {y}_{a} + ( {y}_{b} - {y}_{a} ) \frac{( x - {x}_{a} )}{( {x}_{b} - {x}_{a} )} \qquad ( EQ . 1 )$$

In equation 1, y corresponds to a characteristic and x corresponds to a time in the play length of the playlist. Moreover, xₐ and x_{b} correspond to the time associated with a first and a second media asset, respectively, and yₐ and y_{b} correspond to the characteristics associated with the first and second media assets, respectively.

For example, the objective of a playlist may be to wake a user at a specific time (e.g., the eight minute mark of the playlist). The media guidance application may, therefore, populate a playlist with media assets of gradually increasing volume until the peak volume at the designated wake-up time (e.g., the eight minute mark). Furthermore, the media guidance application may normalize the average volume of all media assets into categories on a scale from zero to eight, in which zero corresponds to a category of media assets with low average volumes and eight corresponds to a category media assets with high volumes. In this example, a first media asset, with a play length of four minutes and having a low average volume (e.g., corresponding to a first category of zero), is assigned at the zero minute mark of the play length of the play list (e.g., a time in the playlist when a user is sleeping). A second media asset, having a high average volume (e.g., corresponding to a second category of eight), is assigned at the eight minute mark of the play list (e.g., the time the user is to be awoken). Consequently, the media guidance application interpolates a media asset in a third category, corresponding to an average volume of four, at the four minute mark, (i.e. representing the end of the play length of the first media asset) using, for example, equation 1. By interpolating the media assets in the playlist, the media guidance application may gradually wake a user as the wake-up time approaches.

At step 1008, the media guidance application determines whether or not the retrieved media asset corresponds to a playlist time. For example, the media guidance application may require a media asset that has a play length of four minutes (e.g., there is a four minute gap between two previously selected media assets or the determined object may change after four minutes).

If the retrieved media asset does not correspond to the time of the playlist, the media guidance application proceeds to step 1006 and selects a different media asset (e.g., retrieved from storage 308 (FIG. 3)), which is compared to the playlist objective at step 1004. For example, if the play length of a media asset is too long.

If the retrieved media asset does correspond to the time of the playlist, the media guidance application proceeds to step 1010 and assigns the retrieved media asset to the playlist (e.g., as Location Information A 510 (FIG. 5)). In some embodiments, the media guidance application may (e.g., using control circuitry 304 (FIG. 3)) crop or extend (e.g., repeat a portion of) a retrieved media asset in order to facilitate inclusion of the retrieved media asset in the playlist.

At step 1012, the media guidance application determines whether or not there is additional time in the playlist. For example, the media guidance application determines whether or not the sum of the play lengths of each assigned media asset corresponds to the play length (e.g., as determined by playlist length option 220) of the playlist. If there is additional time in the playlist, the media guidance application returns to step 1002. If there is no additional time in the playlist, the media guidance application proceeds to step 1014, and presents the playlist (e.g., playlist 224 (FIG. 2)) to a user (e.g., as display 200 (FIG. 2)) on a display screen (e.g., display 312 (FIG. 3)) of a user device (e.g., user equipment device 402, 404, and/or 406 (FIG. 4)).

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method.

FIG. 11 is a flowchart of illustrative steps for generating and updating a media playlist based on bio-metric data of a user in accordance with some embodiments of the disclosure. Process 1100 may be used to generate a media playlist (e.g., playlist 514 (FIG. 5)) on display device (e.g., display 100 (FIG. 5)). It should be noted that process 1100 or any step thereof, could occur on, or be provided by, any of the devices shown in FIGS. 3-4. For example, process 1100 may be executed by control circuitry 304 (FIG. 3) as instructed by the media guidance application (e.g., implemented on any of the devices shown and described in FIG. 4).

For example, in some embodiments, the media guidance application may be used to maintain or change a user's current bio-metric status. For example, the media guidance application may generate and update a media playlist to encourage a sleeping user that wishes to sleep to continue to sleep (e.g., by playing soothing music). Moreover, if the media guidance application determines that a user is not sleeping (e.g., has woken up) or is not having a restful sleep (e.g., is tossing or turning), the media guidance application may adjust the media assets in the media playlist to rectify the situation.

For example, as discussed above in relation to FIG. 3, the media guidance application may incorporate or have access to a detection module (e.g., detection module 316 (FIG. 3)), which may include various components. The components may monitor various types and amounts of bio-metric data. For example, the detection module may monitor, including, but not limited to, a heartbeat, a breathing pattern, a blood pressure, a blood-alcohol level, an internal temperature, and/or any other type of bio-metric data associated with a user, as discussed throughout this disclosure. In addition, as discussed above, the media guidance application may use audio and/or video data to determine various types of bio-metric data associated with a user (e.g., as discussed above).

In step 1102, the media guidance application is initiated. For example, in some embodiments, the media guidance application may be initiated when the user device (e.g., user equipment 402, 404, and/or 406 (FIG. 4)) upon which the media guidance application is implemented is powered-on. In some embodiments, the media guidance application may be initiated in response to a user input (e.g., via user input interface 310 (FIG. 3) selecting selectable option 204 (FIG. 2)).

At step 1104, the media guidance application determines a bio-metric objective. For example, in some embodiments, the media guidance application may determine a bio-metric objective similar to other objectives based on information received from one or more sources (e.g., detection module 316 (FIG. 3), information received via user input interface 310 (FIG. 3), mathematical computations of processing circuitry 306 (FIG. 3), and/or information received from a cross-reference with a database located at storage 308 (FIG. 3), media content source 416 (FIG. 4), media guidance data source 418 (FIG. 4), and/or a device/location accessible via communications network 414 (FIG. 4)).

For example, the media guidance application may receive user inputs (e.g., via user input interface 310 (FIG. 3)) into a display (e.g., display 500 (FIG. 5)) to determine one or more objectives. Alternatively or additionally, the media guidance application may determine one or more objectives without user input (e.g., via detection module 316 (FIG. 3)). For example, the media guidance application may determine the objective of a current trip is to sleep by receiving bio-metric data (e.g., via detection module 316 (FIG. 3)) indicating that the user is currently sleeping. Based on the fact that the user is currently sleeping, the media guidance application may automatically establish “Maintaining Sleep” as the bio-metric objective. In another example, the media guidance application may determine that, based on a cross-reference with a database, a user typically sleeps at the current time. For example, the media guidance application may incorporate or have access to a local (e.g., located at storage 308 (FIG. 3)) or remote (e.g., located at media content source 416 (FIG. 4)), media guidance data source 418 (FIG. 4), and/or a device/location accessible via communications network 414 (FIG. 4)) database (e.g., a lookup table) in which the media guidance application may query (e.g., request a sleep schedule of a user) to determine whether a user is likely to want to sleep and/or a time at which the user should sleep (e.g., to minimize jetlag). Therefore, because a user typically sleeps at the current time, the media guidance application determines that the bio-metric objective is to encourage a user to sleep.

At step 1106, the media guidance application cross-references a database to locate available media assets. For example, the media application may query a database located locally (e.g., on storage 308 (FIG. 3)) or remotely (e.g., at media content source 416 (FIG. 4) or media guidance data source 418 (FIG. 4)) to determine the pool of media assets from which a media asset may be selected.

At step 1108, the media application retrieves an available media asset. For example, in some embodiments, the media guidance application may perform multiple iterations of process 1100, and with each iteration process a different media asset of the available media assets. At step 1110, the media application determines whether the media asset has a characteristic that corresponds to the bio-metric objective. For example, if a bio-metric objective to encourage a user to sleep, the media guidance application may determine whether or not the media asset is soothing or classical music. If so, the media application proceeds to step 1114. If not, the media application proceeds to step 1112 and retrieves a different media asset because the currently retrieved media asset does not have a characteristic corresponding to the bio-metric objective.

In some embodiments, each media asset may correspond to information (e.g., a data file) describing the characteristics of that media asset. In some embodiments, this information may be received/retrieved from local (e.g., storage 308 (FIG. 3)) or remote (e.g., media content source 416 (FIG. 4) or media guidance data source 418 (FIG. 4)) database separately or in conjunction with the media asset. Using this information, the media guidance application may determine whether or not a particular media asset has a particular characteristic. For example, in some embodiments, the database may be structured as a lookup table. The media guidance application may input (e.g., via control circuitry 304 (FIG. 3)) the particular characteristics, and the database may return an indication of whether or not the media asset corresponds to that characteristic. Based on this information, the media guidance application (e.g., via control circuitry 304 (FIG. 3)) may determine whether or not the media asset is suitable for the media playlist (i.e. achieves the bio-metric objective).

Additionally or alternatively, the database may include information about whether or not the media asset is suitable for or achieves the particular bio-metric objective. For example, the database may include a data field, which indicates the particular objectives that the media asset is suitable for. In some embodiments, this information may be further adjusted based on information received about the particular user. For example, there may be a particular genre of music that the user finds soothing. This information may be incorporated into the database and used to find suitable media assets for each bio-metric objective.

At step 1114, the media guidance application generates a media playlist based on the bio-metric objective, which includes the media asset having a characteristic that achieves the bio-metric objective as determined in step 1110. As described in detail in relation to FIG. 10, to generate the playlist, the media guidance application may (e.g., via control circuitry 304 (FIG. 3)) select one or more media assets (e.g., retrieved from a database located locally (e.g., storage 308 (FIG. 3)) or remotely (e.g., media content source 416 (FIG. 4)), in which the sum of the play length for the selected media assets corresponds to the length of time corresponding to the current trip of the user, and in which the media assets correspond to the determined objective. For example, the media guidance application may determine that a user will be on a flight for four hours based on the estimated time of arrival associated with the flight. The media guidance application may further determine a bio-metric objective of the user is to minimize the blood-pressure or heart-rate of the user. The media guidance application may retrieve a plurality of media assets featuring classical music (e.g., to encourage the user to relax). The media guidance application may then compile the classical music into a playlist that lasts the four hours of the flight.

At step 1116, the media playlist is presented to the user. For example, the media guidance application may present a playlist (e.g., playlist 514 FIG. 5)) to a user on a display (e.g., display 312 (FIG. 3)) of a user equipment device (e.g., user equipment device 402, 404, and/or 406 (FIG. 4)).

At step 1118, the media guidance application receives bio-metric data. For example, as described in relation to FIG. 3 above, the media guidance application may incorporate or have access to various sources of information, including bio-metric data associated with a user. For example, detection module 316 (FIG. 3) may include various components (e.g., a video detection component, an audio detection component, etc.) as well as components for use in detecting and/or retrieving data about a physiological state or status of the user (e.g., bio-metric data). For example, the media guidance application may detect changes in both physiological (e.g., drowsiness, perspiration level, etc.) and behavioral (e.g., awareness, activeness, voice patterns, anxiety, etc.) characteristics of a user. In some embodiments, receiving bio-metric data may require the bio-metric analysis option 528 to be initiated. Additionally or alternatively, the media guidance application may automatically initiate the bio-metric analysis or have the bio-metric analysis initiated by default.

At step 1120, the media guidance application compares the bio-metric data of the user to the bio-metric objective. For example, the bio-metric objective of a user may be to maintain a blood alcohol level below a certain level. In such a case, the media guidance application may periodically or continually monitor the blood alcohol level of the user (e.g., via detection module 316 (FIG. 3)). If the media guidance application determines that the bio-metric data does not correspond to the bio-metric objective (e.g., the blood-alcohol level of a user is too high), the media guidance application returns to step 1108 to retrieve an available media asset. For example, the media guidance application may retrieve a message to indicate to the user to stop drinking alcohol or to eat food. If the media guidance application determines that the bio-metric data does correspond to the bio-metric objective (e.g., the blood-alcohol level of a user is below the designated level), the media guidance application returns to step 1116 and continues to present the media playlist.

For example, if the media guidance application detects a change to the bio-metrics of a user, the media guidance application may rectify the media playlist to include a second media asset selected to achieve the bio-metric objective. Alternatively, the media guidance application may detect no status change or that the bio-metric data corresponds to the bio-metric objective. For example, the eye contact detection component or the breathing cycle detection component, incorporated into and/or accessible to the media guidance application (e.g., via detection module 316 (FIG. 3)), may detect that a user who wished to sleep has fallen asleep.

In some embodiments, the user may be associated with information (e.g., a data file) describing the typical bio-metric of the user. In some embodiments, this information may be received/retrieved from local (e.g., storage 308 (FIG. 3)) or remote (e.g., media content source 416 (FIG. 4) or media guidance data source 418 (FIG. 4)). For example, using this information, the media guidance application may determine whether or not a particular breathing pattern or heart-rate is normal for a user or indicates that the user is currently sleeping. For example, in some embodiments, the database may be structured as a lookup table. The media guidance application may input (e.g., via control circuitry 304 (FIG. 3)) the particular bio-metric of the user it needs to obtain, and the database may return the particular bio-metric data (e.g., the normal heart-beat rate of a user when the user is sleeping). Based on this information, the media guidance application (e.g., via control circuitry 304 (FIG. 3)) may determine whether or not the bio-metric data corresponds to the bio-metric objective.

In some embodiments, the media guidance application may determine a likelihood that a media asset will achieve a particular objective. For example, the media guidance application may determine (e.g., via control circuitry 304 (FIG. 3)) a first likelihood that a first media asset may achieve the bio-metric objective. For example, a likelihood that a media asset may achieve a particular objective may be included in information (e.g., a data file) describing the media asset. In some embodiments, this information may be received/retrieved from local (e.g., storage 308 (FIG. 3)) or remote (e.g., media content source 416 (FIG. 4) or media guidance data source 418 (FIG. 4)).

The media guidance application may compare the first likelihood to a threshold likelihood (e.g., designated by control circuitry 304 (FIG. 3)), and in response to determining that the first likelihood exceeds the threshold likelihood, identifying the first media asset as achieving the bio-metric objective. Furthermore, in response to determining that the bio-metric data of a user (e.g., as received in step 1118) does not correspond to the bio-metric objective, the media guidance application may rectify the media playlist to include a second media asset selected to achieve the bio-metric objective. When selecting the second media asset, the media guidance application may determine (e.g., via control circuitry 304 (FIG. 3)) a second likelihood that indicates the likelihood that the second media asset achieves the bio-metric objective.

Furthermore, when rectifying the media playlist, the media guidance application may raise the threshold likelihood and require the second media asset to exceed the raised threshold likelihood. For example, if a bio-metric objective requires a user to wake up, the media guidance application may select a loud media asset to be presented in the media playlist. If the loud media asset does not wake the user up, then the media asset may select a very loud media asset.

It is contemplated that the steps or descriptions of FIG. 11 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method.

FIG. 12 is a flowchart of illustrative steps for automatically determining media playlist objectives based on a purpose of the current trip in accordance with some embodiments of the disclosure. Process 1200 may be used to generate a media playlist (e.g., playlist 514 (FIG. 5)) on display device (e.g., display 100 (FIG. 5)). It should be noted that process 1200 or any step thereof, could occur on, or be provided by, any of the devices shown in FIGS. 3-4. For example, process 1200 may be executed by control circuitry 304 (FIG. 3) as instructed by the media guidance application (e.g., implemented on any of the devices shown and described in FIG. 4).

At step 1202, the media guidance application is initiated. For example, in some embodiments, the media guidance application may be initiated when the user device (e.g., user equipment 402, 404, and/or 406 (FIG. 4)) upon which the media guidance application is implemented is powered-on. In some embodiments, the media guidance application may be initiated in response to a user input (e.g., via user input interface 310 (FIG. 3) selecting selectable option 204 (FIG. 2)).

At step 1204, the media guidance application determines whether or not the travel itinerary is being received by a user input. For example, in some embodiments, the media guidance application determines the travel itinerary (e.g., destination 602, departure point 604, travel route 606 (FIG. 6)) based on various sources. For example, the media guidance application may receive user inputs (e.g., via user input interface 310 (FIG. 3)) describing the travel itinerary (e.g., via Itinerary Information option 520 (FIG. 5)). If the media guidance application receives the travel information via a user input, the media guidance application proceeds to step 1208.

If the media guidance application does not receive the travel itinerary via a user input, the media guidance application proceeds to step 1206 and retrieves the travel itinerary without user input before proceeding to step 1208. For example, the media guidance application may determine the travel itinerary using detection module 316 (FIG. 3)). For example, to determine the route of a flight, the media guidance application may cross-reference a database located locally (e.g., storage 308 (FIG. 3)) or remotely (e.g., media content source 416, media guidance data source 418, and/or any device located via communications network 414 (FIG. 4)) describing a potential flight path associated with the flight.

Additionally or alternatively, the detection module may access a user device (e.g., a smartphone associated with a user) and extract daily planner information such as calendar entries, which indicate the travel itinerary. The media guidance application may also access public sources (e.g., on-line airline, bus and/or train schedules) to obtain travel itinerary information. In some embodiments, the media guidance application may access public sources of information upon determining the user has a relationship to the information. For example, in response to determining a user bought a train ticket (e.g., via credit card purchase information received by detection module 316 (FIG. 3)), the media guidance application may automatically access the train schedule via the Internet.

At step 1208, the media guidance application determines a travel itinerary associated with a current trip. For example, based on the travel itinerary information received either by a user input (e.g., step 1204) or without a user input (e.g., step 1206), the media guidance application determines various details (e.g., destination 602, departure point 604, travel route 606 (FIG. 6)) associated with the current trip. Furthermore, in response to receiving some details (e.g., destination 602 and departure point 604 (FIG. 6)), the media guidance application may determine other remaining details (e.g., travel route 606 (FIG. 6) or the length of time of the current trip) by accessing various sources as described above.

At step 1210, the media guidance application retrieves a detail from the travel itinerary. For example, as a travel itinerary is received (e.g., as described above), the media guidance application may store each detail of the travel itinerary in a database. For example, the media application may populate or generate a database located locally (e.g., on storage 308 (FIG. 3)) or remotely (e.g., at media content source 416 (FIG. 4) or media guidance data source 418 (FIG. 4)) to store the various details of the travel itinerary.

At step 1212, the media guidance application determines whether or not the retrieved detail is indicative of a purpose of the current trip. For example, if the user both vacations and works in at destination, the destination may not be indicative of the purpose of the current trip. In another example, the departure point of the current trip may also not be indicative of a purpose of the current trip.

In some embodiments, to determine whether or not the retrieved detail is indicative of a purpose of the current trip, the media application may query a detail characteristic database regarding a characteristic of a detail. For example, each detail (e.g., stored in local (e.g., storage 308 (FIG. 3) or remote (e.g., media content source 416 (FIG. 4) or media guidance data source 418 (FIG. 4) storage) may correspond to information (e.g., a data file) describing the particular characteristics of the detail. In some embodiments, this information may be received/retrieved from local (e.g., storage 308 (FIG. 3)) or remote (e.g., media content source 416 (FIG. 4) or media guidance data source 418 (FIG. 4)) storage separately or in conjunction with the detail. Using this information, the media application may determine whether or not the retrieved detail is indicative of a purpose of the current trip. For example, in some embodiments, the database may be structured as a lookup table. The media application may input (e.g., via control circuitry 304 (FIG. 3)) the particular detail, and the database may output whether or not the detail is indicative of a purpose of the current trip.

If the media guidance application determines that the detail is not indicative of the purpose of the trip, the media guidance application proceeds to step 1214, selects a different detail, and returns to step 1210. If the media application determines that the detail is indicative of the purpose of the current trip, the media guidance application proceeds to step 1216.

At step 1216, the media guidance application cross-references the selected detail with a database to locate information about the detail. For example, after determining that a detail is indicative of a purpose of the current trip, the media guidance application may search for additional information associated with the detail. For example, information about the destination may indicate that the destination is typically associated with vacation travel. In another example, information about July 4^{th} may indicate that it is a federal holiday and/or occurs during the peak of summer travel season. For example, any of the details of the travel itinerary (e.g., a destination of the current trip, a length of stay at the destination, a weekday of the current trip, or a return date of the current trip, etc.) may indicate a particular purpose of the trip.

Furthermore, personal information about the user may also be searched. For example, if a user is originally from a small town or has family in the small town, the user media guidance application may determine (e.g., via control circuitry 304 (FIG. 3)) that it is more likely the user is travelling to the small town for personal than professional reasons. Likewise, if the information about the user indicates that the user's employer has an office at the destination of the travel itinerary, or information received from a daily planner function associated with the user indicates the user has a business meeting tomorrow, the media guidance application may determine that it is more likely the user is travelling for professional as opposed to personal reasons.

For example, when determining the purpose of the current trip, the media guidance application may identify whether or not information about the detail indicates that a destination of the current trip is associated with a personal or professional contact of a user, that the destination of the current trip is associated with a personal or professional activity of the user, that a length of stay at the destination is associated with a weekday, a weekend, or a holiday, or that the current trip occurs near a holiday or weekend.

At step 1218, the media guidance application determines if there are any more details in the travel itinerary. If so, the media guidance application returns to step 1210. In not, the media guidance application proceeds to step 1220. At step 1220, the media guidance application determines a purpose of the current trip based on the information about the detail. For example, by aggregating all the information associated with one or more details, the media guidance application may determine the purpose of the current trip is personal or professional. In some embodiments, the media guidance application may determine a likelihood that the current trip is associated with a particular purpose. For example, based on the information, the media guidance application may determine (e.g., via control circuitry 304 (FIG. 3)) a likelihood that the current trip is for educational reasons, and compare that amount to a threshold likelihood. If the likelihood exceeds the threshold likelihood, the media guidance application will determine that the purpose is correct.

At step 1222, the media playlist cross-references the purpose with a database to locate a playlist objective associated with the purpose. In some embodiments, to determine a playlist objective associated with the purpose, the media application may query a database associated with playlist objectives. For example, each purpose (e.g., stored in local (e.g., storage 308 (FIG. 3) or remote (e.g., media content source 416 (FIG. 4) or media guidance data source 418 (FIG. 4) storage) may correspond to one or more playlist objectives (e.g., as indicated by a data file in the database). In some embodiments, this information may be received/retrieved from local (e.g., storage 308 (FIG. 3)) or remote (e.g., media content source 416 (FIG. 4) or media guidance data source 418 (FIG. 4)) storage. Using this information, the media application may determine the playlist objective associated with the purpose. For example, in some embodiments, the database may be structured as a lookup table. The media application may input (e.g., via control circuitry 304 (FIG. 3)) the particular purpose, and the database may output one or more playlist objectives associated with the purpose.

At step 1224, the media guidance application generates a playlist. For example, as described in step 816 of FIG. 8 above, the media guidance application may generate a media playlist based on a playlist objective. For example, the media guidance application may generate a playlist based on the determined length of time corresponding to the current trip and the playlist objective. As described in detail in relation to FIG. 10, to generate the playlist, the media guidance application may (e.g., via control circuitry 304 (FIG. 3)), selects one or more media assets (e.g., retrieved from a database located locally (e.g., storage 308 (FIG. 3)) or remotely (e.g., media content source 416 (FIG. 4)), in which the sum of the play length for the selected media assets corresponds to the length of time corresponding to the current trip of the user, and in which the media assets correspond to the playlist objective.

At step 1226, the media guidance application presents a playlist. For example, the media guidance application may present a playlist (e.g., playlist 514 FIG. 5)) to a user on a display (e.g., display 312 (FIG. 3)) of a user equipment device (e.g., user equipment device 402, 404, and/or 406 (FIG. 4)).

It is contemplated that the steps or descriptions of FIG. 12 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for generating a media playlist using a media guidance application, the method comprising:
determining a travel itinerary associated with a current trip of a user;
determining an objective of the media playlist, wherein the media playlist is accessed by the user during the current trip of the user;
generating the media playlist based on the determined objective and the determined travel itinerary; and
in response to detecting an adjustment to the determined travel itinerary, rectifying the media playlist based on the determined objective and the adjustment to the determined travel itinerary.

2. The method of claim 1, further comprising determining the travel itinerary based on a user input received by a navigation system.

3. The method of claim 1, further comprising determining the objective based on a user input indicating the objective.

4. The method of claim 1, wherein the travel itinerary includes information associated with at least one of a destination location, a departure location, an arrival time, a departure time, and a travel route.

5. The method of claim 1, wherein the objective of the media playlist comprises minimizing jetlag, and wherein the generated media playlist includes at least one user notification regarding an activity to minimize jetlag.

6. The method of claim 1, wherein the objective of the media playlist comprises presenting a location specific media asset, and wherein the generated media playlist includes a media asset that corresponds to a geographic position of the user.

7. The method of claim 1, wherein generating the media playlist based on the determined objective and the determined travel itinerary further comprises:
determining a length of time corresponding to the current trip of the user;
determining a play length for each media asset of a plurality of media assets; and
selecting a subset of the plurality of media assets, wherein a sum of the play lengths of the subsets corresponds to the length of time corresponding to the current trip of the user.

8. The method of claim 1, further comprising in response to determining a change in the determined objective, rectifying the media playlist based on the change and the determined travel itinerary.

9. The method of claim 8, wherein determining the change to the determined objective comprises:
monitoring bio-metric data related to the user;
detecting a status change of the user based on the bio-metric data; and
cross-referencing the status change of the user in a database to determine whether the detected status change affects the determined objective.

10. The method of claim 8, wherein the status change is associated with a level of drowsiness of the user.

11. A system for generating a media playlist using a media guidance application, the system comprising control circuitry configured to:
determine a travel itinerary associated with a current trip of a user;
determine an objective of the media playlist, wherein the media playlist is accessed by the user during the current trip of the user;
generate the media playlist based on the determined objective and the determined travel itinerary; and
in response to detecting an adjustment to the determined travel itinerary, rectify the media playlist based on the determined objective and the adjustment to the determined travel itinerary.

12. The system of claim 11, further comprising control circuitry configured to determine the travel itinerary based on a user input received by a navigation system.

13. The system of claim 11, further comprising control circuitry configured to determine the objective based on a user input indicating the objective.

14. The system of claim 11, wherein the travel itinerary includes information associated with at least one of a destination location, a departure location, an arrival time, a departure time, and a travel route.

15. The system of claim 11, wherein the objective of the media playlist comprises minimizing jetlag, and wherein the generated media playlist includes at least one user notification regarding an activity to minimize jetlag.

16. The system of claim 11, wherein the objective of the media playlist comprises presenting a location specific media asset, and wherein the generated media playlist includes a media asset that corresponds to a geographic position of the user.

17. The system of claim 11, wherein generating the media playlist based on the determined objective and the determined travel itinerary further comprises:
determining a length of time corresponding to the current trip of the user;
determining a play length for each media asset of a plurality of media assets; and
selecting a subset of the plurality of media assets, wherein a sum of the play lengths of the subsets corresponds to the length of time corresponding to the current trip of the user.

18. The system of claim 11, further comprising control circuitry configured to rectify the media playlist based on the change and the determined travel itinerary in response to determining a change in the determined objective.

19. The system of claim 18, wherein determining the change to the determined objective comprises:
monitoring bio-metric data related to the user;
detecting a status change of the user based on the bio-metric data; and
cross-referencing the status change of the user in a database to determine whether the detected status change affects the determined objective.

20. The system of claim 18, wherein the status change is associated with a level of drowsiness of the user.

21-30. (canceled)
